(19) United States
(12) Patent Application Publication
(10) Pub. No.: US 2013/0130009 A1
(43) Pub. Date: May 23, 2013

(54) THIN SLAB OF A COMPOSITE MATERIAL COMPRISING A SOLID FILLER AND A THERMOPLASTIC BINDER

(71) Applicant: Arend Kuindert van Helden, Amersfoort (NL)

(72) Inventor: Arend Kuindert van Helden, Amersfoort (NL)

(73) Assignee: Echotect B.V., NL-2288 GK Rijswijk (NL)

(21) Appl. No.: 13/698,980

(22) PCT Filed: May 11, 2011
(86) PCT No.: PCT/NL2011/050319

§ 371 Date: Feb. 4, 2013

Related U.S. Application Data
(60) Provisional application No. 61/346,610, filed on May 20, 2010.

(30) Foreign Application Priority Data
May 20, 2010 (EP) 10163403.8

(51) Int. Cl. B28B 1/14

(52) U.S. Cl. CPC B28B 1/14
USPC 428/220; 264/237

(57) ABSTRACT

The present invention relates to an essentially isotropic slab of engineered stone, said slab having a thickness of about 2 mm to about 10 mm and preferably a width of about 0.2 m to about 3.0 m, wherein said slab is made from a composite material comprising about 50 to about 95 wt. % of solid filler and about 5 to about 50 wt. % of a thermoplastic binder, based on the total weight of the essentially isotropic slab, wherein the essentially isotropic slab has a warpage of less than about 1 mm/m. The present invention also relates to a process for manufacturing an essentially isotropic slab of engineered stone.

### FIELD OF THE INVENTION

The present invention relates to a thin slab made of a composite material comprising a solid filler and a thermoplastic binder. The thin slab according to the present invention can conveniently be used as decoration elements, e.g. plates or slabs, which can for example very suitable be used in construction of floors, ceilings, wall panels, vanity tops, kitchen work surfaces or kitchen tops, bathrooms, internal and external cladding and other two-dimensional shapes by extrusion and or injection moulding techniques. The present invention also relates to a process for manufacturing such thin slabs.

### BACKGROUND OF THE INVENTION

Polymers and blends thereof with appropriate components have been used for many years as a staple material for the manufacture of short-life consumer goods such as drink bottles and food containers. However, due to their low biological degradability, such polymers and blends thereof are of great concern to the environment. Recycling of such polymers and blends thereof into valuable end-use products is therefore highly desirable. Processes for manufacturing such valuable end-use products from recycled polymers are for example disclosed in GB 2396354, WO 96/02373, WO 02/090288, U.S. Pat. No. 6,521,155, U.S. Pat. No. 6,583,217 and U.S. Pat. No. 6,899,839, all incorporated by reference herein. However, such processes are not suitable for manufacturing thin slabs, i.e. slabs having a thickness of 10 mm or less.

Thin slabs made of engineered stone are known in the art. For example, Bretonstone® slabs are commercially available with sizes of 125×306 cm up to 165×330 cm and may have finished thicknesses in the range of 7 to 30 mm. These slabs are manufactured from curable resins and filler materials by the well-known vibro-compression vacuum process which is disclosed in for example U.S. Pat. No. 5.928.585, incorporated by reference. The slabs have a thickness of at least 10 mm. However, the vibro-compression vacuum process is very complicated and the products made by this process need post-finishing such as calibration.

WO 2007/138529, incorporated by reference, discloses slabs comprising 19 wt. % cured polyester resin and 81 wt. % quartz filler which were manufactured with the vibro-compression vacuum process. However, the thickness of the slabs is not disclosed.

Respecta® slabs based on engineered stone comprising fillers such as quartz, granite and marble, and binders such as curable polyester resins, acrylate resins and epoxy resins are commercially available in thicknesses of 5 to 30 mm. These slabs are manufactured by a casting technique, wherein a mixture of the binder and the filler is cast under vacuum, cooled, cut to the desired size, post-cured and further processed. It is believed that part of the process is disclosed in U.S. Pat. No. 5.024.531, incorporated by reference.

US 2008/0111267, incorporated by reference, discloses slabs having a thickness of 10 mm to 30 mm which are manufactured from stone aggregates and cement paste.

WO 2008/0122428, incorporated by reference, discloses slabs which are manufactured by a casting process and which may have a length of up to about 4.1 m and a width of up to about 1.3 m. The thickness of the slabs is, however, not disclosed.

WO 2010/128853 and WO 2010/128854, incorporated by reference, disclose slabs having an average thickness of about 2.5 mm to about 50 mm. Example 1 of

European patent application WO 2010/128853 discloses a slab of 150 mm by 158 mm having a thickness of 3 mm which is made from recycled polyethylene terephthalate and silica (average diameter about 0.25 mm) in a weight ratio of 16 wt. % to 84 wt. %. The slabs are made in a press mould.

Slabs that are made by casting have the disadvantage that they require one or more additional after-finishing steps, in particular to improve surface smoothness and surface flatness. Casting methods also provide inhomogeneous, non-isotropic slabs since due to gravity higher amounts of solid filler are found in the lower parts of the slab and higher amounts of thermoplastic binder are found in the upper parts of the slab.

Surface flatness (also known as “warpage”) can be measured according to test method 7 of European standard test method EN-14617-16 (2005), “Determination of dimensions, geometric characteristics and surface quality of modular tiles”, incorporated by reference. The procedure is essentially as follows. An appropriate calibration plate (usually made of glass or metal) having accurate dimensions (including a thickness of 10 mm) and straight, flat sides is placed on three accurately positioned studs, wherein the centre of each stud is 10 mm from the side of the calibration plate. Three pairs of dial gauges are used to determine several dimension characteristics (length, width, thickness, straightness of sides, rectangularity and warpage) which are placed on appropriate positions. Three dial gauges are used to determine warpage and are set to suitable known values. The calibrating plate is then removed and the slab to be tested is placed on the studs. The readings of the three involved dial gauges are recorded to determine centre curvature, edge curvature and warpage. The maximum warpage is then expressed in mm relative to the length of the diagonal D of the slab.

The processes known from the prior art do not provide thin slabs having an acceptable warpage and require post treatment. Consequently, there is still a need in the art to provide an efficient process for manufacturing thin slabs, in particular thin slabs having a highly aesthetic appearance and a low warpage, wherein post proceeding steps such as calibration can be omitted to a large extent or even totally.

### SUMMARY OF THE INVENTION

The present invention relates to an essentially isotropic slab of engineered stone, said slab having a thickness of about 2 mm to about 10 mm and preferably a width of about 0.2 m to about 3.0 m, wherein said slab is made from a composite material comprising about 50 to about 95 wt. % of solid filler and about 5 to about 50 wt. % of a thermoplastic binder, based on the total weight of the essentially isotropic slab, wherein the essentially isotropic slab has a warpage of less than about 1 mm/m.

The present invention further relates to the use of the thin slabs for the manufacture of floors, floor tiles, ceilings and ceiling tiles, wall panels, vanity tops, kitchen work surfaces, kitchen tops, bathrooms, internal and external cladding and other two-dimensional shapes by extrusion and or injection moulding techniques.

The present invention also relates to the use of the thin slabs for constructing floors, floor tiles, ceilings and ceiling tiles, wall panels, vanity tops, kitchen work surfaces, kitchen work tops, bathrooms, internal and external cladding and other two-dimensional shapes by extrusion and or injection moulding techniques.

The thin slabs according to the present invention have very smooth surfaces, are very flat, i.e. a low deviation from flatness or low warpage, are dimensionally stable upon storage and transport and are easy to handle due to a high flexural strength. An additional and important economical advantage of the thin slabs of the present invention is that calibration is hardly or not necessary which implies less raw material costs, processing costs and waste disposal costs.

### DETAILED DESCRIPTION OF THE INVENTION

### Definitions

The verb “to comprise” as is used in this description and in the claims and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there is one and only one of the elements. The indefinite article “a” or “an” thus usually means “at least one”.

In this document, the term “recycled polyethylene terephthalate” is used to indicate material originating from packaging applications, e.g. beverage bottles and food containers, comprising polyethylene terephthalate and optionally other polyesters and non-polyethylene terephthalate components such as remnants of paper labels, glues, inks and pigments, polypropylene caps and aluminium caps. The packaging applications may also have multilayered structures. They may further include ethylene vinyl acetate (EVA), nylon and other polyamides, polycarbonate, aluminium foil, epoxy resin coatings, polyvinyl chloride (PVC), polypropylene, LDPE, LLDPE, HDPE, polystyrene, thermosetting polymers, textile, and mixtures thereof. Such packaging applications may also comprise recycled (polymeric) materials. Consequently, in this document, the term “recycled polyethylene terephthalate” is preferably a material comprising about 90 wt. % to about 100 wt. % of polyethylene terephthalate and about 0 wt. % to about 10 wt. % of non-polyethylene terephthalate components, based on the total weight of the material, wherein the fraction of non-polyethylene terephthalate components preferably comprises about 0.001 wt. % to about 10 wt. %, more preferably about 0.001 wt. % to about 5 wt.% of non-polymer components, based on the total weight of the fraction of non-polyethylene terephthalate components.

The term “modified polyethylene terephthalate” is also well known in the art and refers to copolymers of ethylene glycol and terephthalic acid which further comprise monomers such as isophthalic acid, phthalic acid, cyclohexane dimethanol and mixtures thereof.

The term “ambient temperature”, although well known to the person skilled in the art, is herein defined as a temperature of about 15° C. to about 40° C.

The term “warpage” as used herein defines the deviation from flatness of the essentially isotropic slab of engineered stone according to the present invention and is expressed as a deviation (in mm) relative to the length of the diagonal D of the essentially isotropic slab (in m) in accordance with test method 7 of European standard test method EN-14617-16 (2005). Hence, “a warpage of less than about 1 mm/m” means that the deviation of the surface of the essentially isotropic slab is less than about 1 mm per m slab diagonal D.

### The Thermoplastic Binder

According to the present invention, the thermoplastic binder comprises about 60 wt. % to about 100 wt. % of a thermoplastic polyester, based on the total weight of the binder. Preferably, the thermoplastic binder comprises about 75 wt. % to about 100 wt. % of a thermoplastic polyester, more preferably about 75 wt. % to about 90 wt. % and in particular about 80 wt. % to about 85 wt. % of the thermoplastic polyester. The thermoplastic polyester is preferably selected from the group of, optionally modified, optionally recycled polyethylene terephthalate and polybutylene terephthalate. The thermoplastic polyester is most preferably recycled polyethylene terephthalate. The thermoplastic polyester has preferably an intrinsic viscosity in the range of about 0.50 dl/g to about 0.90 dl/g, more preferably about 0.60 dl/g to about 0.85 dl/g, most preferably about 0.70 dl/g to about 0.84 dl/g, at 25° C. according to ASTM D 4603.

The thermoplastic binder according to the present invention comprises about 0 wt. % to about 40 wt. % of a polyolefin, preferably about 0 wt. % to about 25 wt. %, more preferably about 10 wt. % to about 25 wt. %, and in particular about 15 wt. % to about 20 wt. %, based on the total weight of the thermoplastic binder.

The polyolefin is preferably selected from polyolefins based on linear or branched C₂-C₁₂ olefins, preferably C₂-C₁₂ α-olefins. Suitable examples of such olefins include ethylene, propylene, 1-butene, 2-butene, isobutene, 1-pentene, 1-hexene, 1-octene and styrene. The polyolefins optionally comprise a diolefin, e.g. butadiene, isoprene, norbornadiene or a mixture thereof. The polyolefins may be homopolymers or copolymers. Preferably, the polyolefins are selected from the group consisting of polyolefins comprising ethylene, propylene, 1-hexene, 1-octene and mixtures thereof. Additionally, the polyolefins may be essentially linear, but they may also be branched or star-shaped. The polyolefins are more preferably selected from polymers comprising ethylene, propylene and mixtures thereof. Even more preferably, the polyolefin is a propylene polymer, in particular a polypropylene. Preferably the density of the polyolefin is in the range of about 0.90 kg/dm³ to about 0.95 kg/dm³ according to ASTM D 792. Preferably, the melt flow rate of the propylene polymer is about 0.1 g/10 min (230° C., 2.16 kg) to about 200 g/10 min (230° C., 2.16 kg) according to ASTM D 1238.

According to the invention, the thermoplastic binder can be used in the form of grinded or milled particles having a maximum weight of about 1 gram. It is, however, preferred that the thermoplastic binder is used in the form of flakes having preferably a size of about 2-10 mm by about 2-10 mm (about 0.5 mm to about 3 mm thickness).

### The Solid Filler

As the solid filler, different materials may be used. Suitable examples include mineral particles, cement particles, concrete particles, sand, recycled asphalt, recycled crumb rubber from tyres, clay particles, granite particles, fly ash, glass particles and the like. Preferably, the solid filler is a calcite based material which may be of natural or synthetic origin (such as marble) and/or a silica based material (such as quartz). Optionally, the solid filler may be constituted from different sources having different particle size distributions. However, it is preferred that that the maximum average coarse particle diameter is about 1.2 mm or less and that the minimum average coarse particle diameter is about 3 μm or more.

### The Essentially Isotropic Slab

According to the present invention, the essentially isotropic slab is made from a composite material comprising about 50 to about 95 wt. % of solid filler and about 5 to about 50 wt. % of a thermoplastic binder, based on the total weight of the essentially isotropic slab, wherein the essentially isotropic slab has a warping of less than about 1 mm/m, preferably of less than about 0.7 mm/m, even more preferably of less than about 0.5 mm/m. Preferably, the essentially isotropic slab is made from a composite material comprising about 60 to about 95 wt. % of solid filler and about 5 to about 40 wt. % of a thermoplastic binder, based on the total weight of the essentially isotropic slab. More preferably, the essentially isotropic slab is made from a composite material comprising about 70 to about 95 wt. % of solid filler and about 5 to about 30 wt. % of a thermoplastic binder, based on the total weight of the essentially isotropic slab. The composite material has preferably a density of about 1.5-3 kg/dm³, more preferably about 2.0-2.5 kg/dm³.

The essentially isotropic slab according to the present invention has preferably a length of about 0.2 m to about 5.0 m, more preferably about 0.5 m to about 4.0 m. The slab has preferably a width of about 0.2 m to about 3.0 m, more preferably about 1.0 m to about 2.0 m. The slab has further a thickness of about 2 mm to about 10 mm, preferably about 3 mm to about 10 mm, more preferably about more than 3 mm to about 10 mm, even more preferably about 4 mm to 9 mm, yet even more preferably about 5 mm to about 9 mm, yet even more preferably more than about 5 mm to about 9 mm, even more preferably more than about 5 mm to about 8 mm and in particular to more than about 5 mm to about 7 mm, e.g. about 6 mm.

The essentially isotropic thin slab can be translucent.

The essentially isotropic thin slab according to the present invention has favourable properties. For example, they are characterised by a high alkali resistance making them very suitable for constructing floors, kitchen work surfaces and kitchen tops. The thin slabs also have good mechanical properties. In particular, it is preferred that the thin slab has a flexural strength of at least about 25 N/mm² according to test method NEN EN 198-1. In addition, it is preferred that the compression strength is at least about 50 N/mm² according to test method NEN EN 196-1.

The thin slabs according to the present invention also show low thermal expansion, very little warping and low brittleness. For example, U.S. Pat. No. 6.583.217, incorporated by reference herein, discloses that thin slabs made from composite materials consisting of recycled polyethylene terephthalate and fly ash showed a shrinkage of 2.2% (100 wt. % recycled polyethylene terephthalate) to 0.7 wt. % (30 wt. % recycled polyethylene terephthalate, 70 wt. % of fly ash). In contrast, it was found that shrinkage of the thin slabs manufactured according to the process of the present invention was virtually independent from thermoplastic binder content.

The thin slabs may further comprise other additives commonly used in engineering stone products, e.g. pigments, colorants, dyes and mixtures thereof. The maximum amount of such additives is preferably less that about 5 wt. %, based on the total weight of the thin slab. The thin slabs may further comprise as additive a water scavenging component such as calcium oxide.

### Process

The present invention also relates to a process for manufacturing an essentially isotropic slab of engineered stone, said slab having a thickness of about 2 mm to about 10 mm and a width of about 0.2 m to about 3.0 m, wherein the process comprises the following subsequent steps:
(a) feeding a solid filler and a thermoplastic binder to a mixing device;
(b) mixing the solid filler and the thermoplastic binder in the mixing device to obtain a composite material;
(c) forming the composite material as obtained in step (b) into a thin slab; and
(d) cooling the thin slab as obtained in step (c) to a temperature of greater than about 75° C.

### Mixing Step

The mixing process according to step (b) of the process according to the present invention may be performed in any suitable mixing device or in a plurality of mixing devices. If several mixing devices are used, they may differ from each other and they do not need to be identical. Suitable mixing devices include batch mixing devices, extruders (e.g. single-screw, double screw) and kneading devices which are all known in the art. It is, however, preferred to employ a mixing device that enables continuous operation of the process according to the present invention. Consequently, extruders and kneading devices are preferred mixing devices for the process according to the present invention.

According to the present invention, in step (a) the solid filler and the thermoplastic binder are fed to the kneading device in a weight ratio of about 1:1 to about 20:1. Preferably, this weight ratio is about 2:1 to about 15:1, more preferably about 4:1 to about 10:1. Since the thermal conductivity of the thermoplastic binder is far less that that of the solid filler, low binder level increases the thermal conductivity of the composite material and of the thin slab thereby reducing internal stresses in the latter. In addition, the cooling process can be better controlled at higher thermal conductivity of the composite material and of the thin slab manufactured thereof.

When the solid filler and/or the thermoplastic binder are fed to the mixing device (in step (a) of the process according to the present invention), the solid filler, the thermoplastic binder or both may optionally be subjected to a pre-heat step as is for example disclosed in WO 02/090288, incorporated by reference. However, they may also be fed without a pre-heat step, i.e. that the solid filler and/or the thermoplastic binder are around ambient temperature when fed to the mixing device.

Furthermore, step (b) of the process according to the present invention is performed at a temperature of about 230° to about 350° C., more preferably at a temperature of about 270° to about 320° C.

It is also preferred that step (b) of the process according to the present invention is performed at a total shear energy per unit volume E of about 10⁸ Pa to about 10⁹ Pa. In extruders, the total shear energy per unit volume is usually much higher (e.g. at least 10¹⁰ Pa; cf. for example U.S. Pat. No. 6,472,460, incorporated by reference).

In the process according to the present invention, the energy input during step (b) is at least about 300 kJ per kg mixture of the solid filler and the thermoplastic binder. Preferably, the energy input is not more than about 1000 kJ per kg mixture. More preferably, the energy input is in the range of about 300 kJ per kg mixture to about 700 kJ per kg mixture.

### Compaction

In extruders, mixing and compaction may occur within the same device. On the other hand, the use of a kneading device enables to perform compaction in a separate, distinct step. Accordingly, the step (b) of the process of the present invention may optionally comprise a compaction step which may be conducted simultaneously with or subsequently after the mixing step.

Preferably, the compaction step is performed in a conveying extruder which is operated at a pressure of about 5×10³ kPa to about 5×10⁴ kPa, more preferably of about 10⁴ kPa to about 3×10⁴ kPa.

### Forming

The forming step may also be conducted with devices known in the art, e.g. by compression moulding, wherein the composite material is loaded into a mould and the thin slab is formed under a load, by injection moulding, or by extrusion, wherein the material is pressed through a die into the desired shape, and a knife is used to dimension the thin slab to the desired length. The latter method is in particular advantageous when the thin slab is a wall panel, a vanity top, a kitchen work surface or a kitchen top.

### Cooling Step

It was surprisingly found that cooling conditions had a significant impact on important properties of the thin slab according to the invention as produced along conventional process conditions. In addition, prior art processes suffered from the disadvantage that they are not very efficient, in particular because these processes make use of moulding steps to form the thin slab. Hence, the thin slabs could only be manufactured batch wise, whereas continuous manufacturing would be highly desirable for efficiency and consistency of product quality.

It appeared that the mechanical properties of the thin slabs according to the present invention could be greatly improved by applying certain stringent cooling conditions and/or by using particular cooling devices. In particular, it appeared that cooling the upper surface and the bottom surface of the slab provided improved properties, e.g. less warpage, higher flexural strength, higher compression strength and less surface cracks.

According to the invention, it is preferred that in step (d) the slab is cooled to a temperature greater than about 70, more preferably greater than about 75° C. Even more preferably, the slab is cooled to a temperature of greater than about 80° C., even more preferably to a temperature greater than about 85° C.

According to the invention, it is preferred that in step (d) the slab is cooled to a temperature of about 120° C. or less, more preferably about 100° C. or less and most preferably about 90° C. or less.

Although fast cooling is beneficial in terms of productivity, slow cooling avoids thermal stresses while cooling. Thermal stresses cause undesired effects such as warpage, bending and cracking. However, thin slabs have the advantage that they have smaller temperature gradients across the thickness of the slab which enables faster cooling with respect to thicker shaped articles.

Desired properties, e.g. warpage, strength and the number of surface cracks, could be further improved by performing step (d) by belt cooling.

Belt cooling such as single belt and double belt cooling, is well known in the art and is often used in the steel industry. However, steel has very different properties and must fulfill other requirements than the composite material according to the present invention.

Belt cooling is operated as follows. The thin slab to be cooled is loaded on a belt, usually made of steel. Since steel has an excellent thermal conductivity, heat can be dissipated quite rapidly. The rate of heat dissipation can be controlled by e.g. the run speed of the belt. The belt itself is cooled by external sources, e.g. sources spraying water and/or air against the belt. Preferably, when water is used as coolant, there is no contact between the thin slab and the cooling water. The cooling water can optionally be collected and, after cooling to the desired temperature, be recycled into the cooling process. It is therefore preferred that the cooling is achieved by using air, water or a combination thereof.

According to the present invention, the belt cooling can be performed by single belt cooling or double belt cooling, wherein one or more single belt cooling devices and/or one or more double belt cooling devices are used, respectively. Optionally, the cooling system may comprise a combination of one or more single belt cooling devices and one or more double belt devices. However, according to the present invention, it is preferred that at least a double belt cooling device is used.

Double belt cooling has as one advantage that the thin slabs can be produced with increased capacity, as the product is in contact with two cooling belts. Another important advantage is that the whole cooling process can be better controlled. Furthermore, double belt cooling provides more flexibility with respect to the thickness of the thin slab, i.e. that thicker slabs can be cooled at about the same efficiency as less thicker slabs can be cooled on a single belt device.

In a double belt cooling device, the thin slab is fed onto the upper surface of the lower belt which transports it to the cooling zone or cooling zones, where the pressure of the upper belt ensures essentially constant contact with the surfaces of both the lower belt and the upper belt thereby providing an efficient and controlled cooling of the thin slab.

According to the present invention, it is preferred that the amount of energy per weight equivalent withdrawn from the thin slab during step (d) is about 100 kJ/kg to about 250 kJ/kg, more preferably about 150 kJ/kg to about 200 kJ/kg. The amount of energy withdrawn from the thin slab is calculated as the ratio of the cooling power of the cooling device (in kW) and the throughput of the thin slab or thin slabs (in kg/s; mass flow) and is therefore expressed as kJ/kg. Hence, the amount of energy is related to the weight (in kg) of the thin slab to be cooled.

In cooled thin slabs, the stress distribution is dependent from the well known Biot number. The Biot number (Bi) is a dimensionless number which is used in unsteady-state (or transient) heat transfer calculations and it relates to the heat transfer resistance inside and at the surface of the thin slab. The Biot number (dimensionless) is defined as:

$$Bi = \frac{Hd}{L}$$

wherein H is the heat transfer coefficient at the surface of the thin slab (in W/m².K), 2d is the thickness of the thin slab (or characteristic length which is the ratio of the volume of the thin slab and the surface area of the thin slab; in m) and L is the heat conductivity of the thin slab (in W/m.K). When the Biot number is (substantially) higher than 10, the number of internal stresses increases significantly which is obviously undesired for the thin slabs according to this invention. Consequently, according to the present invention, it is preferred that the Biot number is less than about 10, more preferably less than about 5, even more preferably less than about 4, yet even more preferably less than about 2.5. This will result in very low thermal stresses and thereby reduced undesired effects such as warping, bending and cracking However, if the Biot number is less than 0.1, the heat transfer within the thin slab is much greater then the heat transfer from the surface of the thin slab (which implies that there are hardly any temperature gradients within the thin slab). Hence, according to the present invention it is preferred that the Biot number is about 0.1 or higher, preferably about 0.2 or higher, even more preferably about 0.4 or higher and in particular about 0.5 or higher. Consequently, according to this embodiment of the present invention, the Biot number is in particular in the range of about 0.5 to about 2.5.

### EXAMPLES

### Example 1

Recycled PET and marble (average coarse particle diameter about 0.5 mm) in a weight ratio of 16 wt. % to 84 wt. % was processed in a single screw kneader (Buss kneader MDK-140; L/D=11; shear rate (max) 450 s⁻¹, average shear rate (in all loading regions) 112.5 s⁻¹; residence time approximately 2 minutes; 400 kPa maximum pressure) at a temperature of around 275° C. The mixture of recycled PET and silica was fed through a 7 mm die thereby producing a plate having a thickness of about 7 mm which was transferred to a 10 m cooling belt; the temperature at the start of the cooling table was about 275° C. The slab was cooled to about 91° C. After the cooling table the plates were left to cool with ambient air. The plates showed no surface cracks and were not brittle. The amount of energy per weight equivalent withdrawn from the plate during step (d) of the process was about 169 kJ/kg. The Biot number was about 2.0. The warpage was less than 1.0 mm/m slab diagonal D as determined by test method 7 of European standard test method EN-14617-16 (2005).

### Example 2

Recycled PET and marble (average particle diameter about 0.5 mm) in a weight ratio of 15 wt. % to 85 wt. % was processed in a single-screw kneader (Buss MDK 140; L/D=11). The mixture of recycled PET and marble quartz was fed through a 7 mm die thereby producing a plate having a thickness of about 7 mm which was transferred to a cooling belt (Sandvik type DBU; temperature at the start of the cooling belt was about 280° C., temperature at the end of the cooling belt was about 91° C.; length of the cooling belt was 10 m. The amount of energy per weight equivalent withdrawn from the plate during step (d) of the process was about 160 kJ/kg. The Biot number was about 2.1. The plates showed no surface cracks and were not brittle. The warpage was less than 1.0 mm/m slab diagonal D as determined by test method 7 of European standard test method EN-14617-16 (2005).

### Example 3

Recycled PET and quartz (average particle diameter about 0.5 mm) in a weight ratio of 23 wt. % to 77 wt. % was processed in a single-screw kneader (Buss MDK 140; L/D=11). The mixture of recycled PET and marble quartz was fed through a 7 mm die thereby producing a plate having a thickness of about 7 mm which was transferred to a cooling belt (Sandvik type DBU; temperature at the start of the cooling belt was about 270° C., temperature at the end of the cooling belt was about 90° C.; length of the cooling belt was 8 m; The amount of energy per weight equivalent withdrawn from the plate during step (d) of the process was about 186 kJ/kg. The Biot number was about 1.4. The plates showed no surface cracks and were not brittle. The warpage was less than 1.0 mm / m slab diagonal D as determined by test method 7 of European standard test method EN-14617-16 (2005).

### Examples 4-8

Experiments were performed according to kneading conditions described in Example 3 and under the cooling conditions listed in Table 1. The PET used was recycled PET and the filler had an average particle diameter about 0.5 mm. The results are also shown in Table 1. These data show the effect of cooling the thin slab to a temperature up or above the glass transition temperature of the thermoplastic binder on warpage.

TABLE 1

| Example | 4 | 5 | 6 | 7 | 8 |
|---|---|---|---|---|---|
| PET (wt. %) | 23 | 23 | 23 | 23 | 21 |
| Filler (wt. % | 23 (quartz) | 23 (quartz) | 23 (quartz) | 23 (quartz) | 25 (quartz) |
| | 54 (marble) | 54 (marble) | 54 (marble) | 54 (marble) | 54 (marble) |
| Die (mm) | 7 | 7 | 7 | 7 | 7 |
| T (° C.; start belt) | 255 | 264 | 280 | 284 | 279 |
| T (° C.; end belt) | 90 | 67 | 91 | 92 | 63 |
| Cooling energy | 162 | 193 | 185 | 188 | 212 |
| withdrawn (kJ/kg) | | | | | |
| Warping (1.0 | < | > | < | < | > |
| mm/m) | | | | | |

### Examples 5-9

Recycled PET and marble (average particle diameter about 0.5 mm) in various weight ratios were processed in a single-screw kneader (X-Compound CK-150; L/D=16). The mixture of recycled PET and marble quartz was fed through a 7 mm die thereby producing a plate having a thickness of about 7 mm which was transferred to a cooling belt (Sandvik type DBU; length of the cooling belt was 8 m). Warpage was determined by test method 7 of European standard test method EN-14617-16 (2005) as described in Examples 1-3. The data are summarised in Table 2.

TABLE 2

| Example | 5 | 6 | 7 | 8 | 9 |
|---|---|---|---|---|---|
| PET (wt. %) | 23 | 17 | 15 | 14.5 | 18 |
| Filler (wt. % | 77 | 83 | 85 | 85.5 | 82 |
| Die (mm) | 7 | 7 | 7 | 7 | 7 |
| T (° C.; start belt) | 280 | 280 | 282 | 286 | 267 |
| T (° C.; end belt) | 111 | 103 | 79 | 69 | 77 |
| Cooling energy | 165 | 170 | 185 | 197 | 175 |
| withdrawn (kJ/kg) | | | | | |
| Cracks | Yes | Yes | No | Yes | No |
| Warping (1.0 | > | > | < | > | < |
| mm/m) | | | | | |

1. An isotropic slab of engineered stone, having a thickness of about 2 mm to about 10 mm and a warpage of less than about 1 mm/m according to test method 7 of European standard test method EN-14617-16 (2005), the slab comprising a composite material comprising about 50 to about 95 wt % of solid filler and about 5 to about 50 wt. % of a thermoplastic binder, based on the total weight of the isotropic slab and is obtainable by a process comprising the following subsequent steps:
(a) feeding a solid filler and a thermoplastic binder to a mixing device;
(b) mixing the solid filler and the thermoplastic binder in the mixing device at a temperature of 230° to 350° C. to obtain a composite material;
(c) forming the composite material into a thin slab; and
(d) cooling the thin slab to a temperature greater than about 75° C. by belt cooling.

2. The slab according to claim 1, wherein the slab has a width of about 0.2 m to about 3.0 m.

3. The slab according to claim 1, wherein the thermoplastic binder comprises about 60 wt. % to about 100 wt. % of a thermoplastic polyester and about 0 wt. % to about 40 wt. % of a polyolefin, based on the total weight of the thermoplastic binder.

4. The slab according to claim 3, wherein the thermoplastic polyester comprises about 90 wt. % to about 100 wt. % of recycled polyethylene terephthalate.

5. The slab according to claim 3, wherein the polyolefin is a propylene polymer.

6. The slab according to claim 5, wherein the propylene polymer is polypropylene.

7. The slab according to claim 1, wherein the slab has a length of about 0.2 m to about 5.0 m.

8. The slab according to claim 1, wherein the slab is translucent.

9. The slab according to claim 1, wherein the slab has a flexural strength of at least 25 MPa according to standard test method NEN EN 198-1.

10. The slab according to claim 1, wherein step (b) is performed at a total shear energy per unit volume of about 10⁸ Pa to about 10⁹ Pa,

11. The slab according to claim 1, wherein the energy input during step (b) is at least about 300 kJ per kg mixture of the solid filler and the thermoplastic binder.

12. A process for manufacturing an isotropic slab of engineered stone having a thickness of about 2 mm to about 10 mm and a width of about 0.2 m to about 3.0 m, the process comprising the following subsequent steps:
(a) feeding a solid filler and a thermoplastic binder to a mixing device in a weight ratio of about 1:1 to about 20:1;
(b) mixing the solid filler and the thermoplastic binder in the mixing device at a temperature of 230° to 350° C. to obtain a composite material;
(c) forming the composite material into a thin slab; and
(d) cooling the thin slab as to a temperature of greater than about 75° C.

13. The process according to claim 12, wherein the solid filler, the thermoplastic binder or both are subjected to a pre-heat step.

14. The process according to claim 1, wherein step (b) comprises a compaction step which may be conducted simultaneously with or subsequently after the mixing step.

15. The process according to claim 1, wherein step (d) is performed by belt cooling.

16. The process according claim 15, wherein the belt cooling is performed by double belt cooling.

17. An essentially isotropic slab of engineered stone obtainable by the process according to claim 12.

18. (canceled)
